(19) United States
(12) Patent Application Publication
(10) Pub. No.: US 2008/0239067 A1
(43) Pub. Date: Oct. 2, 2008

(54) Optical concatenation for field sequential stereoscpoic displays

(75) Inventor: Lenny Lipton, Los Angeles, CA (US)

Correspondence Address: REAL D - Patent Department, by Baker & McKenzie LLP, 2001 Ross Avenue, Suite 2300, Dallas, TX, 75201, US

(73) Assignee: Real D

(21) Appl. No.: 11/732,303

(22) Filed: Apr. 2, 2007

(51) Int. Cl. H04N 15/00

(52) U.S. Cl. 348/54

(57) ABSTRACT

A device used in projecting or transmitting stereoscopic images is provided. The device includes a multi-section light emitter, such as a “color wheel or a series of light emitting diodes (LEDs) configured to emit light energy in multiple sections. Each section of light energy has an optical attribute associated therewith, such as color. Light energy projected in at least two sequential sections by the multi-section light emitter provides light energy having identical optical attributes, such as identical colors (red, green, or blue) but different perspective views associated with each sequential section, where the same optical attributes being employed in adjacent sections is referred to as “concatenation.” Different polarization attributes or polarization axis orientations may be employed within each section to facilitate stereoscopic image transmission and such concatenation in many cases reduces “judder” or other adverse visual effects.

This application is being filed concurrently with U.S. patent application Ser. No. ______, entitled “Color and Polarization Timeplexed Stereoscopic Display Apparatus,” inventor Lenny Lipton, the entirety of which is incorporated herein by reference.

### BACKGROUND OF THE INVENTION

1. Field of the Invention

The present invention relates to the art of concatenating color and perspective fields for reducing temporal artifacts in a stereoscopic display, and more specifically to techniques useful for single image engine displays using field sequential color.

2. Description of the Related Art

Various types of stereoscopic displays are currently available, and operation of such displays is constantly being evaluated and improved to enhance the stereoscopic viewing experience. Certain projection displays employ what can be called the “additive color timeplex” method. Such a colorplexing display can be combined with time multiplexing of perspective views for stereoscopic projection. A projector known as the DepthQ uses this approach, as do the latest generations of Texas Instruments rear projection television sets employed in, for example, the Samsung brand of television set.

Shuttering or active eyewear represents one answer for realizing a practical and cost efficient consumer stereoscopic application. Another solution uses polarization for image selection with passive analyzing eyewear. The challenge with these types of devices is minimizing the adverse effects, including but not limited to visual effects known as “judder.” Judder is an artifact resulting from non-precisely temporally matched frames, such as interlaced frames in a stereoscopic projected image or movie. Mismatching or imperfect timing can result from various sources, such as power interruptions, timing mismatches, frame loading errors, among other issues, and results in onscreen visual anomalies perceptible by the average viewer.

It would be advantageous to offer a stereoscopic projection design that when employed with optional selection devices reduces adverse effects known in previously available timeplex designs.

### SUMMARY OF THE INVENTION

According to one aspect of the present design, there is provided a device used in projecting or transmitting stereoscopic images is provided. The device includes a multi-section light emitter, such as a “color wheel or a series of light emitting diodes (LEDs) configured to emit light energy in multiple sections. Each section of light energy has an optical attribute associated therewith, such as color. Light energy projected in at least two sequential sections by the multi-section light emitter provides light energy having identical optical attributes, such as identical colors (red, green, or blue) but different perspective views associated with each sequential section, where the same optical attributes being employed in adjacent sections is referred to as “concatenation.” Different polarization attributes or polarization axis orientations may be employed within each section to facilitate stereoscopic image transmission and such concatenation in many cases reduces “judder” or other adverse visual effects. Light emitting diodes (LEDs) illuminated in an additive color sequence may be employed in place of a spinning color wheel.

These and other advantages of the present invention will become apparent to those skilled in the art from the following detailed description of the invention and the accompanying drawings.

### BRIEF DESCRIPTION OF THE DRAWINGS

The present invention is illustrated by way of example, and not by way of limitation, in the figures of the accompanying drawings in which:

FIG. 1A is a simplified cross-sectional layout of a colorplexing rotating projection wheel;

FIG. 1B is a more detailed frontal representation of a color wheel;

FIG. 1C is a typical known color wheel shown in a frontal view;

FIG. 2A is a color wheel and associated projector components modified for projection using polarization for image selection which serves to illustrate an active eyewear selection technique;

FIG. 2B illustrates a color wheel modified for perspective encoding wherein an additive perspective is completed before the next perspective image is presented;

FIG. 2C illustrates the color subfields' order modified so they are concatenated by intermixing the perspective subfields' information;

FIG. 2D illustrates one orientation of polarization axes when combined with the color wheel;

FIG. 2E is an additional set of possible orientations of polarization axes when polarization is employed with the color wheel;

FIG. 3 illustrates a simplified layout of a rear projection embodiment that can serve to illustrate either polarization or occlusion selection;

FIG. 4A shows an illumination source array of light emitting diodes (LEDs) and polarization filters of complementary orientation or handedness;

FIG. 4B shows the use of a rotating polarization wheel with two complimentary polarization filters used in conjunction with LED illumination;

FIG. 4C is similar to FIG. 4B but places the color wheel between the lens and the image engine rather than between the LEDs and the image engine;

FIG. 5 illustrates an electro-optical solution; and

FIG. 6 gives two tables used to determine image and polarization distribution for a color wheel or rotating projection wheel according to the present design, including a table employing concatenation according to the present design.

### DETAILED DESCRIPTION OF THE INVENTION

The present design combines both color and perspective encoding in one embodiment using a spinning color/polarization wheel, or in another embodiment LEDs or similar additive color techniques are employed to illuminate the image engine in a color sequence. In yet another embodiment, active eyewear is used for the occlusion approach to image selection. Polarization may be employed, and three variants of polarization may be used: linear, circular, and achromatic circular. Subfield concatenation can be varied to further enhance performance by reducing undesirable effects such as stereoscopic motion judder. Accordingly, there are many permutations of this design all generally following the basic principles, and a person versed in the art will understand that changing these polarizations is relatively trivial once the general principles enunciated herein are understood, and numerous such variations will fall within the scope of these teachings.

The basic idea of the present design is to combine color and perspective encoding, and make this work subfield-sequentially, or sequentially for each subfield. Both color-sequential and perspective-sequential encoding are known techniques and, as described in accordance with the present design, can work in combination with one another. The result is a front or rear projected color stereoscopic moving image that can be enjoyed by viewing through spectacles having only polarizing analyzers or shuttering (occluding) eyewear. Subfield concatenation in the present design is accomplished not by presenting an entire perspective color sequence, but rather by alternating the perspectives within a color subframe to prevent the stereoscopic judder artifact as will be described herein.

The present solution is a combined color and perspective timeplex solution allowing for a new ordering or concatenation of the color and perspective subframes. Such a solution reduces or eliminates motion artifacts heretofore associated with this kind of display.

The present design also employs a selection technique using an occlusion method with active shuttering eyewear. The teachings described here work equally well with either the concatenation or the occlusion approach as long as the speed of the shutters used in the active eyewear is sufficiently fast. The latest generation of liquid crystal shutters is fast enough. In addition, the design works with either front or rear projection devices.

Currently there are projection video devices that employ spinning color wheels for producing field-sequential additive color. Lately these color wheels are being supplanted by an LED array with colors firing in sequence, but the additive color principle is the same for either. Both the liquid crystal on silicon (LCOS) and the digital micromirror display (DMD) engines offered by Texas Instruments use this approach. Spinning color wheels are used because they are economical and the time-sequential color technology produces good looking color with a single image engine. The color wheel is a rotating device interposed in the optical path between the projection lens and screen, spinning at some multiple of the video field rate. Alternatively, colored LEDs can be used and fired in sequence.

For broadcast television, which uses a complex colorplexing scheme, the projector electronics breaks down the transmitted image into its three (or more) primary color components (red, blue, and green), and these are projected in rapid sequence. For image origination from a computer, there will be three separate color channels, and these channels when received from the computer are stored by the projector and presented in sequence. A typical sequence consists of red, blue, and green colored filters, and the equivalent gray scale images are produced by the image engine and projected in turn through each filter onto a screen. One major variant is where a white light field of luminance information is added to increase the image brightness. Another variant is that additional colors can be used, such as cyan, to increase the color gamut. Typical uses are for front projection for conference rooms and rear projection home televisions. The result of using the additive approach is a good color image at a reduced cost since the projector uses a single image engine.

The alternative is to provide three image engines with appropriate additive-color filters having the light energy combined by optical means. This leads to a greater cost because of optical complexity in terms of deriving an appropriate light source for each engine and subsequently combining the images from the three separate engines and this method is reserved for high end machines.

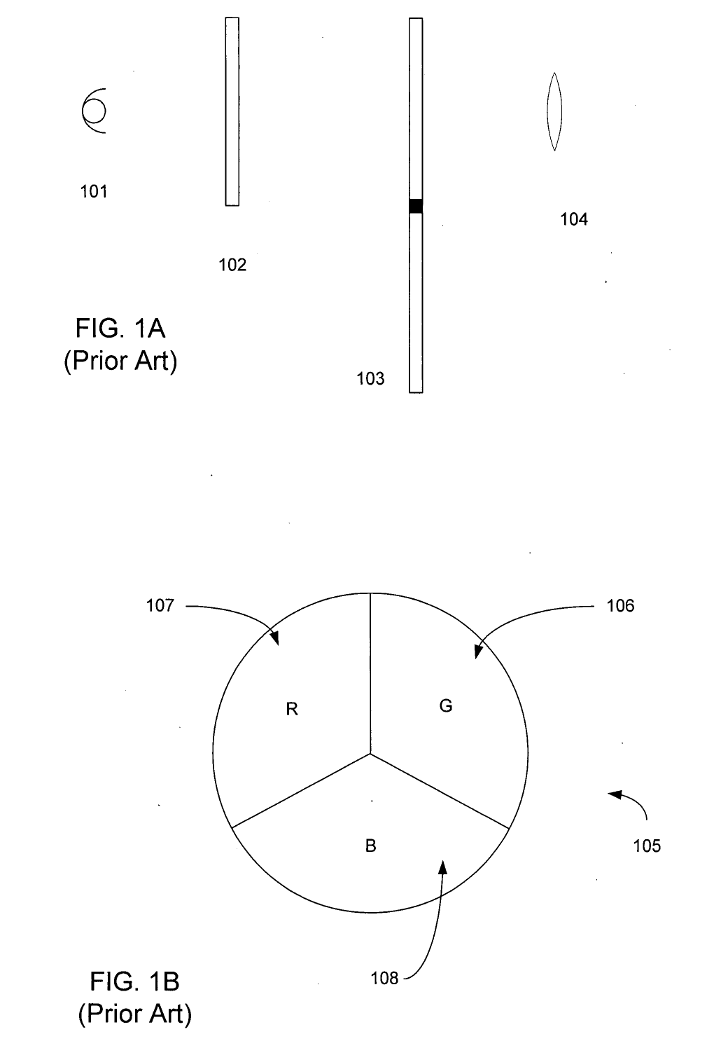

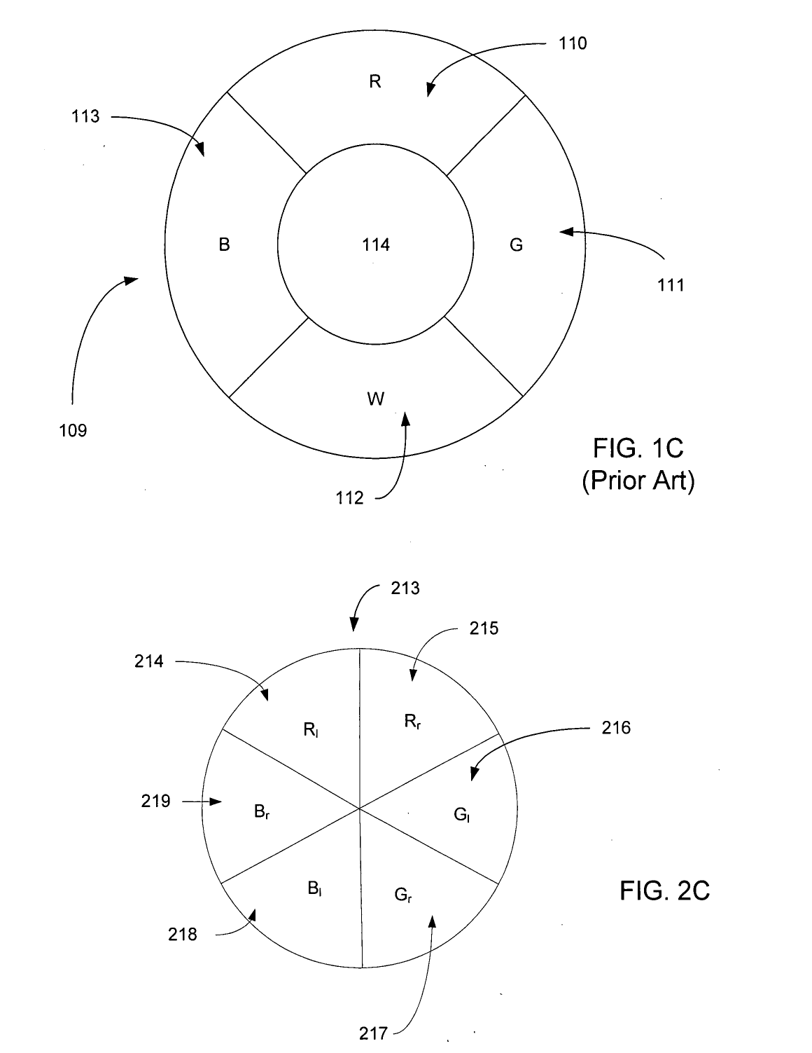

The basic additive color scheme is shown using a simple color wheel technique in FIGS. 1A and 1B. FIG. 1A shows, in cross section, a light source 101, image engine 102, color wheel 103, and lens 104. Corresponding to color wheel 103 is, in FIG. 1B, a diagrammatic representation 105, the color wheel which shows its red 107, green 106, and blue 108 color filter components. This representation is strictly for didactic purposes since a practical design may differ significantly. By way of example FIG. 1C shows one kind of color wheel 109 that is toroidal in design, rotating about axis 114, with red section 110, green section 111, white light section 112, and blue section 113.

In FIG. 1B, for the sake of simplification, a three color wheel is shown as a three segmented device. Other approaches are used such as that shown in FIG. 1C, which in addition to red, green, and blue, adds white light to increase the image brightness. Many other schemes exist for adding additional colors to the wheel to increase the color gamut. There are not illustrated or discussed for the sake of simplification. Nonetheless, the principle described herein, of concatenation of and left and right perspectives before completion of a color subfield remains the guiding principal.

A somewhat different optical system than that indicated in FIG. 1A is often used since FIG. 1A assumes projection with light passing through the imaging engine when in point of fact, in the case of the LCOS and DMD engines, light is reflected from the surfaces of these devices. However, the principle described herein remains unaffected by this optical change since the results are equivalent as the color wheel appears in the same place in the optical path.

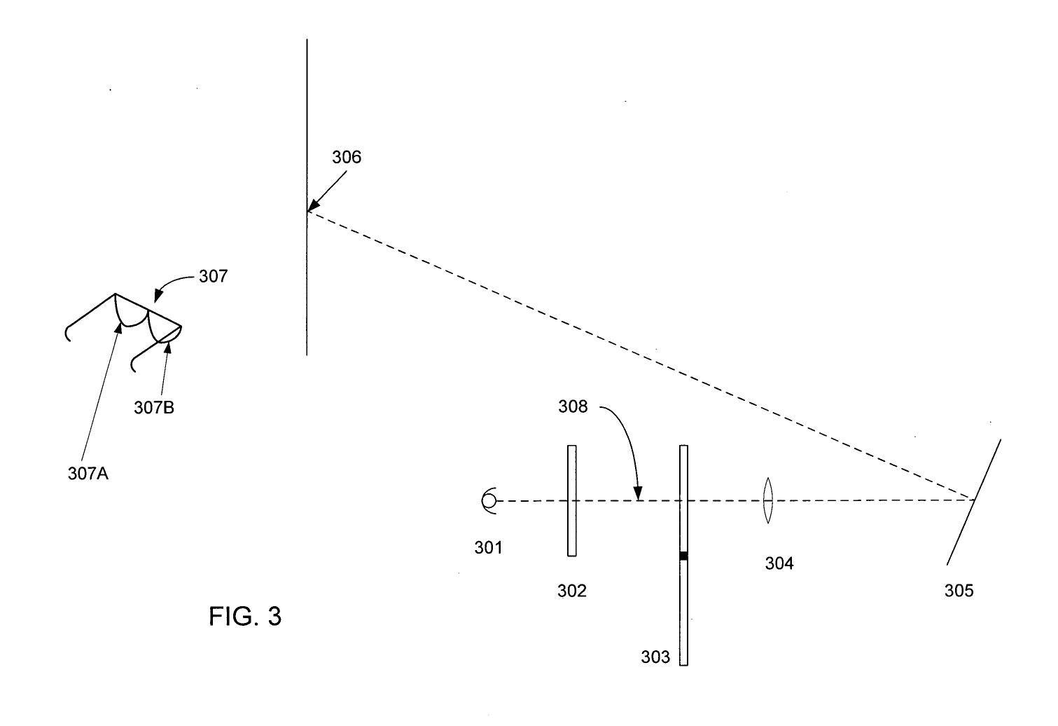

The alternative for rear projection television is shown in FIG. 3. The color wheel 105 spins so that a sector of the wheel covers the light path between the image engine and the lens. In the case of the drawing shown in FIG. 3, color wheel 303 is between the light source and the image engine. Color wheel 303 spins in synchrony with the image subfields (each color element being a subfield) so that every time a new subfield is written the appropriate gray-scale density of the image is filtered by the appropriate sector of the filter. Accordingly, red, green, and blue images from the subfields are rapidly produced, and what the eye sees is an integrated full color image.

The term “field” here has specific meaning. In interlace television, which in the United States uses about 60 fields per second, two complete fields are necessary to produce a complete frame. For the purposes of a field sequential color system, the color wheel 105 may run at 180 fields per second. Each field in a typical arrangement is broken into three subfields—a red, a green, and a blue subfield. No matter what the form of the incoming image information, the image must be presented as red, green, and blue components to be projected in sequence. Then, by what is often described as the persistence of vision, the eye-brain combines the separate images into one full color image. The repetition rate of the color subfields may be twice 180 fields per second to eliminate perceptual artifacts, and as mentioned, a white subfield for luminance information is also a frequent addition, as are additional subfield colors to increase the gamut.

The present technique combines subfield perspectives with color subfield information to produce stereoscopic moving images. A perspective subfield is made up of either a left or right view of the subject and the color subfields are made up of the additive color constituent components of the subject image. Combination and concatenation of the subfields are the subject of this design.

The stereoscopic projection system described here is a plano-stereoscopic projection system in which there are two images—a left and a right image. The term “plano” refers to “planar” so, in effect, two planar images are combined to produce a single stereoscopic image.

FIGS. 1A and 1B, discussed above, are schematic representations prepared for didactic and expository purposes. For example, while shown to comprise three segments, the color wheel in FIG. 1B can be made up of multiple repeating segments, such as six, nine, or twelve or more segments for the red, green, blue arrangement presented, so that the angular velocity of the color wheel can be reduced as the segments pass in front of the image engine. The subfield rate may be increased to suppress visual artifacts as noted.

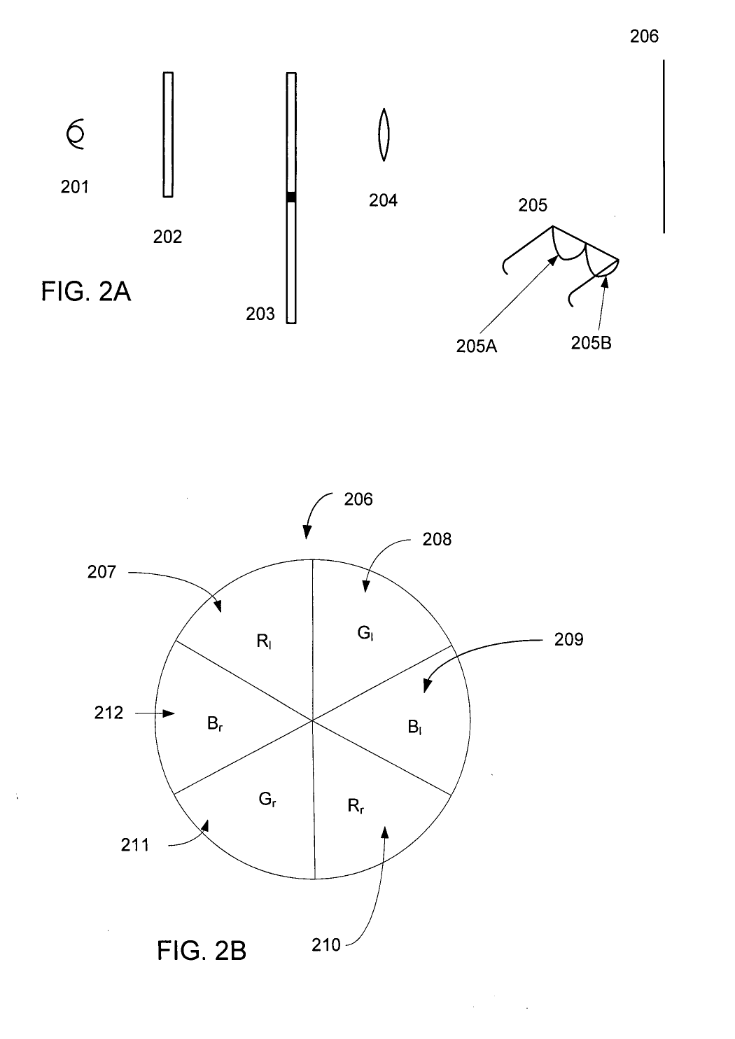

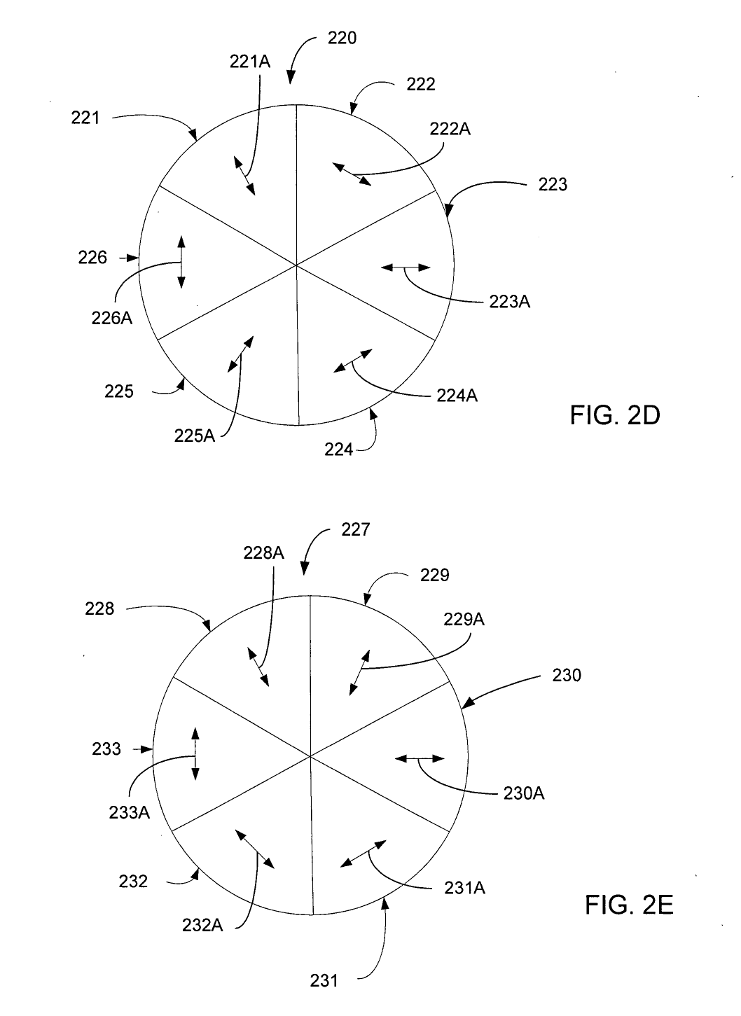

FIG. 2A illustrates a front projection screen layout that can serve to explain both the polarization method of image selection and the occlusion method using active eyewear. For polarization, shown in FIG. 2A are a source of illumination 201, image engine 202, spinning color/polarization wheel 203, and projection lens 204. Screen 206 is typically a polarization conserving screen. Polarization conservation enhances image selection. For the case of occlusion, color wheel 203 is shown and the alternate perspectives are produced without polarization having been added. Eyewear 205 comprise electro-optical shuttering devices with shutters shown at 205A and 205B. Shutters 205A and 205B open and close in synchrony with the video field rate and out of phase with each other. Out of phase operation is known to those versed in the art.

FIG. 3 shows a rear-projection unit that is more popular for television sets in the home and will be described in greater detail below. FIG. 3 can serve to explain both the polarization method of image selection and the occlusion method using active eyewear. For polarization, part 205 is the polarization analyzing eyewear, while analyzers 205A and 205B are the analyzers for the left and right image, respectively.

FIG. 3 shows a rear projection version of the apparatus described with the help of FIG. 2A. Illumination source 301 is modulated by image engine 302 whose image is projected through color wheel 303. The image is formed by lens 304 which is reflected by mirror 305 onto rear projection screen 306. All parts are shown in cross section and are meant to be an overview of the functionality of such a device rather than a specific working design.

Note that color/polarization wheel can be placed between the lens 304 and mirror 305 rather than between image engine and lens. Eyewear selection device 307 is shown with polarizing analyzing filters 307A (left) and 307B (right). Central light ray 308 is indicated to show the light path from lamp to screen. Mirror 305 is representative of one of several such mirrors that are used to fold the optical path and reduce the thickness of the device. This projection setup, as noted, and that of the aforementioned FIG. 2A, assume a tranmissive image engine when in fact such engines are, more often than not, reflection engines and, rather than modulating light by means of absorption, modulate light by means of refection.

For the case of occlusion for image selection, no polarization filters are associated with color wheel 303. Alternate perspectives are produced without polarization having been added. Eyewear 307 represents electro-optical shuttering devices with shutters shown as shutters 307A and 307B. Shutters 307A and 307B open and close in synchrony with the video field rate and out of phase with each other, a generally known technique. As one example, U.S. Pat. No. 5,117,302 shows such a device. Such alternating of perspectives provides for polarization by occlusion, i.e. blocking one eye and then the other.

FIGS. 2B, 2C, 2D, and 2E all show frontal views of the kind of color wheels that can be used in the projectors shown in 203 or 303. FIG. 2B shows a color/perspective wheel 206 made up of sectors R1 207 for the red left image, sector G₁ 208 that uses a green subfield left image, and sector 209 showing a blue left subfield B₁. (The device can be called either a color/perspective wheel or a color/polarization wheel since perspective and polarization are intimately linked) Sector 210 is a sector of the color/polarization wheel using a red right subfield Rᵣ, sector 211 shows the green right subfield Gᵣ, and sector 212 shows the blue right subfield Bᵣ. The drawing is meant to convey the concept and is not intended as a production design, but producing such a design is generally achievable without undue experimentation.

FIGS. 2B and 2C show the combination of color and left/right perspective information, and, although implicit, do not generally concern themselves with the varieties of polarization encoding characteristics that will be explained in conjunction with FIGS. 2D and 2E.

The nomenclature employed herein is that the red, green, and blue subfields use R, G, and B letters. The subscripts “1” and “r” represent the left and right perspective views respectively. Here the R₁G₁B₁ sequence presents one complete perspective view, and when that subframe color perspective is completed a second perspective view is presented as represented by RᵣGᵣBᵣ. This is one possible way to present the perspective information, but other ways may be employed while within the scope of the current design to provide a superior result in terms of suppression of motion judder. Suppression results since the concatenation method provides a closer approximation in terms of presenting the perspective views. The concatenation technique described with the help of FIG. 2B is one in which the system presents a complete set of subfields of one perspective, and then a complete set of subfields of the next perspective.

A stereoscopic image with smoother motion can in many cases be achieved using different concatenation procedures as described herein, and the concatenation principle is shown with reference to FIG. 2C. FIG. 2C shows one possible preferred concatenation variation using color/perspective wheel 213. Subframe 214 represents a red subframe with a left perspective R₁, followed by a red subframe with a right perspective Rᵣ at subframe 215. Segment or sector 216 is green and is meant for the left perspective G₁. Segment or sector 217 is green Gᵣ, and is meant for the right perspective. Segment or sector 218 is a sector of blue B₁ with the left perspective, and segment/sector 219 is a sector of blue Bᵣ with the right perspective.

In contradistinction to FIG. 2B, FIG. 2C illustrates the implementation where the left and right perspectives are concatenated in close proximity to each other. Here a red follows a red, but of the other perspective; a green follows a green, but of the other perspective; and a blue follows a blue, but of the other perspective. In this manner, referred to herein as “concatenation means” among other terms, the time sequence between the left and right perspectives is decreased. In the scheme illustrated with the help of FIG. 2B, an entire perspective and associated color subframe must be formed before presenting the next perspective. In FIG. 2C the left and right perspectives are intertwined and juxtaposed so that they are temporally closer together. This reduces the temporal artifact knows as stereoscopic judder.

One way to eliminate the judder artifact is to use a higher field rate. In other words, if a complete left RGB perspective is presented and a complete right RGB perspective is next presented, the motion artifacts may be mitigated by going to a higher repetition rate. This judder artifact is difficult to describe, but is related to the presentation field rate. The higher the field rate, the less likely it is to “see” this artifact. There is no common language to describe the effect, because it never occurs in the visual field. But when projecting stereoscopic movies or television using the field-sequential technique, this judder can be, obtrusive. As noted the judder or judder can in many cases be mitigated by going to higher field rates, but such higher field rates may be impractical because of various systems limitations and it is better to mitigate the stereoscopic judder by maintaining a lower field rate, by changing the concatenation method as shown in FIG. 2C. This alternative can effectively suppress stereoscopic judder.

A discussion is now in order regarding stereoscopic symmetries in a projection system. Three general classes of stereoscopic symmetries exist, namely the illumination symmetry, the geometric symmetry, and the temporal symmetry. The concern is for the temporal symmetry under consideration here. It is best if left and right images are presented simultaneously because this will preclude stereoscopic judder. One paper on the subject is by Jones and Shurcliff, “Equipment to Measure and Control Synchronization Errors in 3-D Projection,” SMPTE Journal, February 1954, vol. 62. Another discussion on the subject of stereoscopic symmetries is given by Lipton, Foundations of the Stereoscopic Cinema, Van Nostrand Reinhold, 1982.

Therefore, it is important to seek simultaneous projection of the left and right images in a field-sequential stereoscopic system. FIG. 2C illustrates the usual approach to the color wheel perspective timeplexing combination. Such an approach is employed in the latest generation of Texas Instruments DMD light engines offered to its OEM TV set customers as a stereoscopic feature. Intrinsically timeplexing cannot meet the simultaneity condition required by temporal symmetry.

While absolute simultaneous transmission can never be achieved for timeplexing, it is approached or approximated as the rapidity with which the subfields are repeated. The concatenation means described juxtaposes adjacent left and right perspectives in less time than if they were juxtaposed after the system presents a complete additive color sequence. Here simultaneous transmission of the left and right image fields is better approached by concatenating them as described, using the scheme illustrated with the help of FIG. 2C, rather than the concatenation scheme described in conjunction with FIG. 2B.

Viable concatenation methods are possible such as: R₁, Rᵣ, G₁, Gᵣ, B₁, Bᵣ, (FIG. 2C) but an equally effective one is R₁, Gᵣ, B₁, Rᵣ, G₁, Bᵣ, and other obvious variations can be used devised. The important point is that the entire set of color component subfields does not need to be completely presented, but rather the perspectives can be concatenated by a method that places left and right perspectives in closer temporal proximity. Toward this end the first scheme enunciated above, R₁, Rᵣ, G₁, Gᵣ, B₁, Bᵣ, (FIG. 2C), reduces the time between perspectives to the minimum since similar color components are more closely juxtaposed than in any other alternative.

For the case of active occluding eyewear with electro-optical shutters, no polarization encoding is required and the simple sequence given here will suffice to explain the reduction of judder. For completeness, when polarizing selection is employed, the description of such implementation is given below.

FIG. 2D shows wheel 220 with sectors 221, 222, 223, 224, 225, and 226. Each sector has associated with it a polarization axis. Three kinds of polarization can be used: linear, circular, and achromatic circular. The simplest is linear as given in FIG. 2D. In the case of linear polarization, the axis of polarization is described as either being parallel to the color wheel radius or orthogonal to the radius. For example, axis of polarization 221A is along a radius, but in each case it is a radius that bisects the sector 221 into two equal halves. This is the optimum position for the polarization axis. Accordingly, axis 222A is a polarization axis that is orthogonal to a radius that is bisecting a sector. Similarly, all of the other axes 223A, 224A, 225A, and 226A follow a similar prescription that has been laid down here. Axes 223A and 225A are along a radius and bisecting the sectors 223 and 225 respectively, just as the polarization axes represented by 224A and 226A are orthogonal to a radius bisecting the sector.

In the present design, such a polarization disc is combined with a color disc as shown in FIG. 2B, or as combined in the case illustrated with the help of FIG. 2C. The polarization characteristic alternates with each sector. In the case of FIG. 2B, for one complete color sequence—R₁, G₁, and B₁, for example—the polarization axes are parallel to a radius that bisects each sector. In the case of the next perspective sequence—Rᵣ, Gᵣ, and Bᵣ—the polarization axis is orthogonal to a radius bisecting each one of these sectors. The axes' orientation can be inverted just so long as each perspective maintains polarization consistency.

FIG. 2B and FIG. 2E can be read in conjunction with each other. With this construction color wheel 227 has segments 228, 229, 230, 231, 232, and 233. The polarization axes are represented by axes 228A, 229A, 230A, 231A, 232A, and 233A. In the case of axes 228A, 229A, and 230A, the polarization axis is parallel to the radius of the color wheel and bisects each segment. In the case of 231A, 232A, and 233A, the polarization axis for linear polarization is orthogonal to a radius that bisects each segment. In this way a complete color subfield is encoded with a state of polarization.

FIG. 2E illustrates the combination of linear polarizer axes as juxtaposed in conjunction with the color/perspective wheel shown in FIG. 2B. The wheel 227 has sheet polarizer axis for the corresponding segments given as axes 228A, 229A, and 230A all along radii. The axes 231A, 232A, and 233A, corresponding to their associated segments, are at right angles to the radii that pass through them. The color segments R₁, G₁, and B₁, have their axes orthogonal to those of Rᵣ, Gᵣ, and Bᵣ.

The problem with regard to using linear polarization for image selection is explained by the law of Malus. There is an angular dependence of the polarizers and corresponding analyzers so that when the image is viewed, the analyzers in the selection device need to be orthogonal or parallel to the encoded polarization state. Just a few degrees of difference between these states produce significant leakage or ghosting as a result of incomplete occlusion of the left and right channels.

Rotation of the polarization axes are involved because of the spinning wheel's action. Thus there will be a corresponding reduction in polarizer extinction and an increase in image cross talk. The unwanted mixture of the right perspective image into the left image and vice versa is undesirable in a stereoscopic projected image and reduction of this mixture can produce a higher quality overall image presentation. The spinning linear polarization filters must vary their angle with respect to the horizontal or vertical. Depending on the radius of the color wheel, the result can be a reduction in the dynamic range of the polarizer and the analyzer used in the eyewear since the polarizer axes rotation is continually changing angle. Best performance occurs only when the polarizer and analyzer axes (the eyewear polarizers) are orthogonal. Leakage or crosstalk will occur because of the polarizer angular change and the result will be more of an undesirable ghost image.

One approach that can mitigate the angular dependency issue is to use circular polarization. In the case of ordinary circular polarization angular dependence is substantially reduced and for achromatic circular polarization, angular dependence is vastly reduced.

With reference to FIG. 2C, a left circular polarizer is associated with the left perspective components for the R, G, and B color components and a right circular polarizer for the right color components. This mitigates the head-tipping difficulties associated with the use of linear polarizers. Thus color wheel 213 has an association of perspectives and color components as follows: R₁, Rᵣ (214,215), G₁, Gᵣ (216,217), and B₁, Bᵣ (218, 219). The left images have circular polarizers of one handedness associated with them and the right perspectives have the opposite handed circular polarizers so associated. Circular polarizers are made up of a retarder and a linear polarizer, and the linear polarizer component of the circular polarizers typically follows the prescription as shown in FIGS. 2D or 2E.

A superior way of producing the desired image selection described in this disclosure is to use achromatic circular polarizers. Achromatic circular polarizers do not have any angular dependence and can have a high dynamic range. Ordinary circular polarizers are less angularly dependent than linear polarizers for selection, but achromatic circular polarizers have little or no angular dependence. For achromatics, as the color polarization wheel spins, no change occurs in the dynamic range, and this is the preferred embodiment. In other words, an achromatic circular polarizer can be combined as shown in FIG. 2C. A left-handed circular polarizer is combined with R₁, G₁, and B₁, and a right-handed circular polarizer is combined with Rᵣ, Gᵣ, and Bᵣ. One can use left-handed circular polarizers with the right perspective, and vice versa; and there is no limitation here with regard to what we are describing.

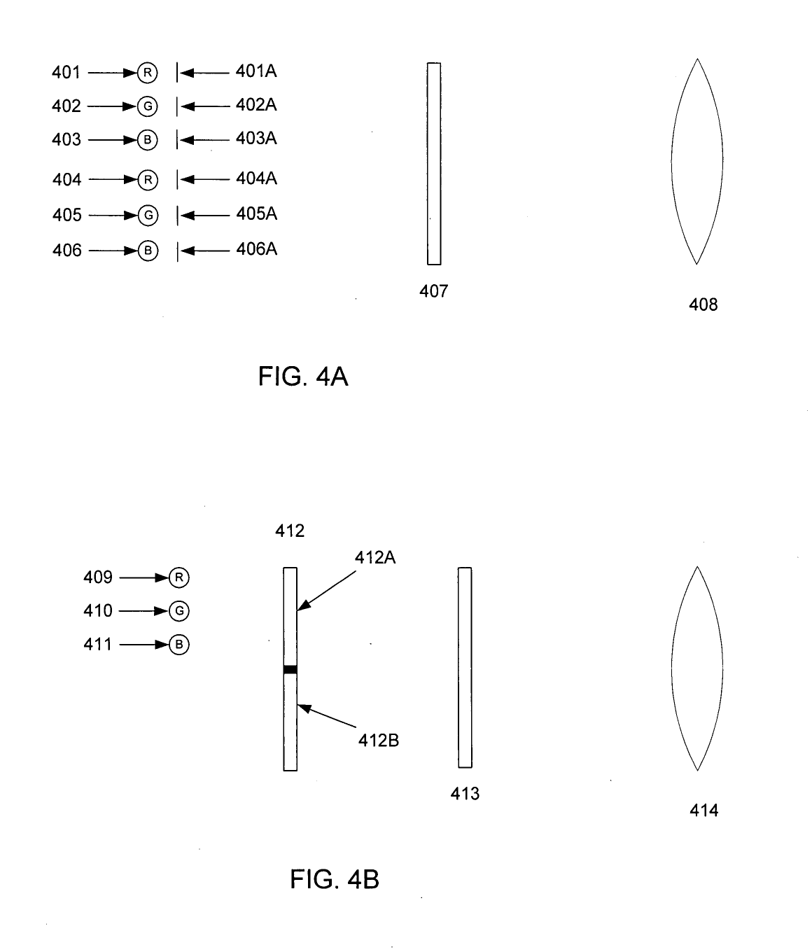

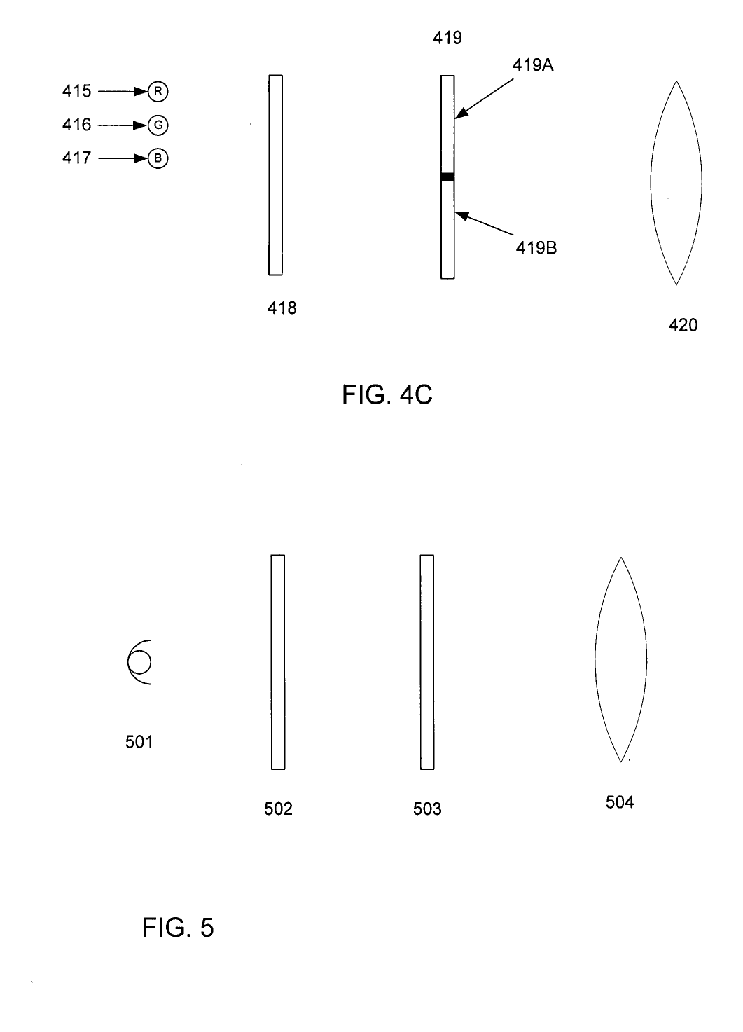

Until recently, the light source used in the projectors has been conventional incandescent or arc lamps. However, light emitting diodes (LEDs) are now available as illumination sources. They are available as red, green, and blue diodes, and are beginning to replace the spinning color wheel and conventional incandescent of enclosed arc lamps because of their brightness, cool running, color purity, and longevity. Therefore, in order to uses these new devices, related devices must be sought to encode polarization as is described with the help of FIGS. 4A, 4B, and 4C. The basic concept of this disclosure can be applied to this new illumination source as is explained below.

While the system has thus far been described with respect to a color wheel, it is to be understood that any type of multi-segment or multi-section light emitter can be employed, where a color wheel is one embodiment of the multi-section light emitter. Other implementations may include a light emitting diode (LED) arrangement or other implementation that can transmit or emit light energy in multiple sections or segments having the properties described herein. Also, the present concatenation process may involve a display or display arrangement other than front or rear projection. For example, a field sequential flat panel display may employ concatenation in this manner, transmitting light energy to certain pixels in succession rather than cycling through red, green, blue, red green, blue, and so forth. Any type of successive light energy transmission may benefit a display system and provide fewer adverse effects, such as judder.

FIG. 4A illustrates an illumination source array of LEDs 401, 402, 403, red, green and blue, respectively. Placed in immediate juxtaposition with these diodes are polarization filters of complementary orientation or handedness. One set is given as LEDs 401A, 402A, and 403A, and the other set for the other perspective is given as 404A, 405A, and 406A. The image engine 407 and projection lens 408 are shown.

FIG. 4B shows the use of a rotating polarization wheel 412 with two complimentary polarization filters 412A and 412B. The diodes are given as diodes 409, 410, and 411, or red, green and blue, respectively. Image engine 413 is shown as is lens 414.

FIG. 4C is a similar setup to that of FIG. 4B but places the color wheel elsewhere in the optical path, namely between the lens and the image engine rather than between the diodes and the image engine. Diodes 415, 416, and 417 are red, green, and blue, respectively. Image engine 418 is positioned between diodes 415, 416, and 417 and color wheel 419, made up of two filters in different polarization states 419A and 419B. Lens 420 is also shown.

FIG. 5 illustrates possible configurations involving an electro-optical solution. The rotating color/perspective wheel is replaced by a polarizing electro-optical switch. Illumination source 501 is located proximate the image engine 502, polarization modulator 503, and lens 504. The positions of image engine 502 and polarization monitor 503 can be interchanged and the polarization switch can be located between the illumination source 501 and the image engine 502 or between the image engine 502 and the lens 504. The rotating color wheel is not used but rather an electro-optical switch or modulator may be employed in its stead, where one skilled in the art would have access to such a switch or modulator. This arrangement can work for either a conventional light source or the diode solution.

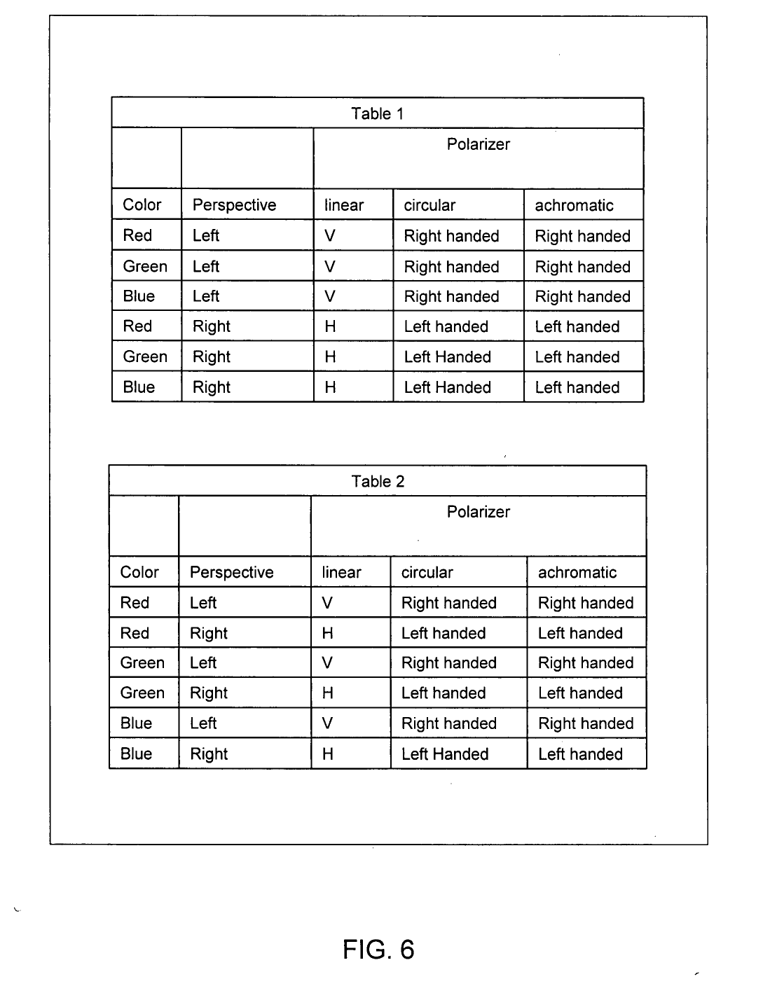

Two tables, Table 1 and Table 2, are given in FIG. 6, where Table 1 shows the method of completing an entire Red, Green, Blue (and white or other colors for an expanded color gamut—not shown) set of fields to build one full color perspective image. The next perspective image is built thereafter. The type of polarizer employed dictates the type of polarization—vertical or horizontal in the case of a linear polarizer, right handed or left handed in the case of a circular polarizer, or right handed or left handed in the case of an achromatic circular polarizer.

Table 2 charts an embodiment in which the left and right perspectives are distributed differently within the concatenation process. In this case the red left is followed by the red right and so forth. In this way the left and right images are brought temporally closer together and the juxtaposition of the image pair halves more nearly approaches the symmetry condition of simultaneity, thereby reducing judder.

The present design can produce a high quality stereoscopic image, preferably using achromatic circular polarization, but the device is not limited to that, and can also work with linear or normal circular polarization. One embodiment uses achromatic circular polarization which enjoys no reduction in image quality or no increase in crosstalk with head tipping, so that when the image is viewed through analyzing spectacles the result is a high quality stereoscopic image.

The improvement described herein, with regard to the reduction in the appearance of the stereoscopic judder artifact, is entirely independent of the selection means, or the eyewear employed by a user to view the stereoscopic image. The preferred concatenation arrangement described provides closer temporal juxtaposition of the subfield perspective elements so that corresponding right and left image subfields are presented in the closest possible juxtaposition with each other. The need for an entire additive color sequence of one perspective to be completed before the presentation of the next perspective is to be avoided and will only exacerbate the artifact.

The design presented herein and the specific aspects illustrated are meant not to be limiting, but may include alternate components while still incorporating the teachings and benefits of the invention. While the invention has thus been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A device configured to project stereoscopic images, comprising:
a multi-section light emitter configured to emit light energy in multiple sections, each section having an optical attribute associated therewith, wherein light energy projected in at least two sequential sections by the multi-section light emitter provides light energy having identical optical attributes but different perspective views associated with each sequential section.

2. The device of claim 1, wherein the optical attribute comprises color.

3. The device of claim 1, wherein the multi-section light emitter comprises a rotating projection wheel.

4. The device of claim 1, wherein the multi-section light emitter comprises a series of light emitting diodes.

5. The device of claim 1, wherein each section is polarized and has a polarization direction associated therewith, and polarization direction differs between at least two adjacent sections.

6. The device of claim 1, wherein each section is polarized and has a polarization orientation associated therewith, and polarization direction is similar for at least two adjacent sections.

7. The device of claim 2, wherein the multi-segment light emitter emits at least two adjacent red sections, at least two adjacent blue sections, and at least two adjacent green sections.

8. The device of claim 1, wherein said device is configured to be employed within a rear projection television device.

9. The device of claim 1, wherein the device is configured to be employed within a front projection screen arrangement.

10. The device of claim 1, wherein each section of the wheel is polarized by a polarization filter attached to the section.

11. A color wheel comprising:
a plurality of segments, each segment comprising:
a colored substantially transparent element; and
a perspective view attribute associated with the colored substantially transparent element;
wherein at least two adjacent segments of the color wheel share the same color but transmission therethrough of light energy results in projected light energy having different perspective view attributes, wherein the use of different perspective view attributes enables stereoscopic image viewing.

12. The color wheel of claim 11, wherein each segment further has a polarization attribute and a polarization direction associated therewith, and polarization direction differs between at least two adjacent segments.

13. The color wheel of claim 11, wherein each segment has a polarization attribute and a polarization orientation associated therewith, and polarization direction is similar for at least two adjacent segments.

14. The color wheel of claim 11, wherein the wheel comprises at least two adjacent red segments, at least two adjacent blue segments, and at least two adjacent green segments.

15. The color wheel of claim 11, wherein said device is configured to be employed within a rear projection television device.

16. The color wheel of claim 11, wherein the device is configured to be employed within a front projection screen arrangement.

17. The color wheel of claim 11, wherein each segment of the wheel is polarized by a polarization filter attached to the segment.

18. A stereoscopic image projection device, comprising:
a light source configured to provide light energy in sections, each section having an optical attribute associated therewith, and further wherein at least two adjacent sections provided by the light source have identical optical attributes and different perspective views;
an image engine positioned proximate the light source; and
a lens positioned proximate the light source and the image engine.

19. The stereoscopic image projection device of claim 18, wherein the light source comprises a plurality of light emitting diodes.

20. The stereoscopic image projection device of claim 18, wherein the light source comprises a rotating projection wheel.

21. The stereoscopic image projection device of claim 20, wherein the image engine is positioned between the light source and the rotating projection wheel.

22. The stereoscopic image projection device of claim 20, wherein the rotating projection wheel is positioned between the light source and the image engine.

23. The stereoscopic image projection device of claim 18, wherein the optical attribute comprises color.

24. The stereoscopic image projection device of claim 18, wherein each section is polarized and has a polarization direction associated therewith.

25. A device configured to display stereoscopic images, comprising:
multi-section light emitters configured to emit light energy in multiple sections, each section emitted having an optical attribute associated therewith, wherein light energy displayed in at least two sequential sections of the multi-section light emitter provides light energy having identical optical attributes but different perspective views associated with each sequential section.

26. The device of claim 25, wherein the optical attribute comprises color.
